(19) United States
(12) Patent Application Publication
(10) Pub. No.: US 2009/0193475 A1
(43) Pub. Date: Jul. 30, 2009

(54) Systems and Methods For Enabling Configurable Context-Specific Actions in Streaming Video

(76) Inventors: Corey Halverson, Cambridge, MA (US); Joe Eldridge, Needham, MA (US); Matt Kaplan, Sharon, MA (US); Dan Lovy, Concord, MA (US); Gabor Vida, Ottawa (CA); Paolo Farago, Ottawa (CA); Tony MacDonell, Ottawa (CA); Ian Shaw, Ottawa (CA); Chris Samuel, Ottawa (CA)

Correspondence Address: CHOATE, HALL & STEWART LLP, TWO INTERNATIONAL PLACE, BOSTON, MA, 02110, US

(21) Appl. No.: 12/021,932

(22) Filed: Jan. 29, 2008

(51) Int. Cl. H04N 7/173

(52) U.S. Cl. 725/87

(57) ABSTRACT

Systems and methods for deploying video content in a video player which enables context-specific actions and policies may comprise a video player operating in a web browser which receives a policy file or a hierarchy of policy files describing specific actions, such as displaying a text, image, link, or video, to be taken when a certain element is encountered or a condition is satisfied in a video. The video player may then receive a video and an accompanying cue file which describes elements within the vide. As the video player plays the video, the player processes the cue file and takes any actions dictated by corresponding policies. In this manner, individual video content may separated from policy decisions such as when to show links or advertisements, and related content to display.

### BACKGROUND OF THE INVENTION

Many businesses and individuals wish to distribute and view video over the internet, often within the context of a web browser. As video is distributed in this form, issues arise relating to the amount of control a distributor has in how a video is displayed, as well as how a distributor can realize revenue from popular videos. Existing technologies may allow commercials, links, or text to be included within distributed videos, however these technologies may have the drawback of requiring changes to the distributed video files themselves. Other technologies may require explicit linking of given videos to given advertisements or resources, such that changing the linking to respond to changing sponsors, changing markets, changing contexts, or user responses is difficult.

### SUMMARY OF THE INVENTION

The present invention broadly relates to systems and methods for deploying video content in a video player which enables context-specific actions and policies. In some embodiments, this comprises a video player operating in a web browser which receives a policy file or a hierarchy of policy files describing specific actions, such as displaying a text, image, link, or video, to be taken when a certain element is encountered or a condition is satisfied in a video. The video player may then receive a video and an accompanying cue file or data stream which describes elements within the video. As the video player plays the video, the player processes the cue file or stream and takes any actions dictated by corresponding policies based on an available context. In this manner, individual video content may be separated from policy decisions such as when to show links, advertisements, related content, or taking any other action with respect to the video and the context.

In one aspect, the present invention relates to a method for enabling context-specific actions with respect to streaming video viewed in a web browser. In one embodiment, the method comprises: receiving, by a video player, one or more associations to be applied to at least one video, each association comprising a key and a resource; receiving, by the video player, at least a portion of a video; receiving, by the video player, one or more cues expressed in a markup language, each cue linking a temporal portion of the video to a key; playing, by the video player, at least a portion of the video; determining, by the video player, a key specified in a first cue corresponds to a key in a first association; and applying, by the video player at the temporal portion of the video specified in the first cue, the resource specified in the first association.

In another aspect, the present invention relates to a client for enabling context-specific actions with respect to streaming video viewed in a web browser. In one embodiment, the client comprises: a transceiver which receives: at least a portion of a video, receives one or more associations to be applied to the at least one video, each association comprising a key and a resource, and receives one or more cues expressed in a markup language, each cue linking a temporal portion of the video to a key; and a processor which executes a video player, the video player playing at least a portion of a video; determines a key specified in a first cue corresponds to a key in a first association; and applies, at the temporal portion of the video specified in the first cue, the resource specified in the first association.

### BRIEF DESCRIPTION OF THE DRAWINGS

The foregoing and other objects, aspects, features, and advantages of the invention will become more apparent and may be better understood by referring to the following description taken in conjunction with the accompanying drawings, in which:

FIG. 1A is a block diagram of one embodiment of a network which may be useful for distributing video;

FIG. 1B is a block diagram showing one embodiment of a system for enabling context-specific actions with respect to streaming video viewed in a web browser;

FIGS. 2A and 2B are block diagrams of example computing devices which may be used as a client or server;

FIG. 3A is an example screenshot of a video player which allows context-specific actions in relation to played videos;

FIG. 3B is an example screenshot of a video editor for which allows context-specific actions in relation to played videos;

FIG. 4 is a flow diagram of one embodiment of a method for enabling context-specific actions with respect to streaming video viewed in a web browser; and

FIGS. 5, 6, 7, and 8 are example displays of a video player taking context specific actions with respect to a played video.

### DETAILED DESCRIPTION OF THE INVENTION

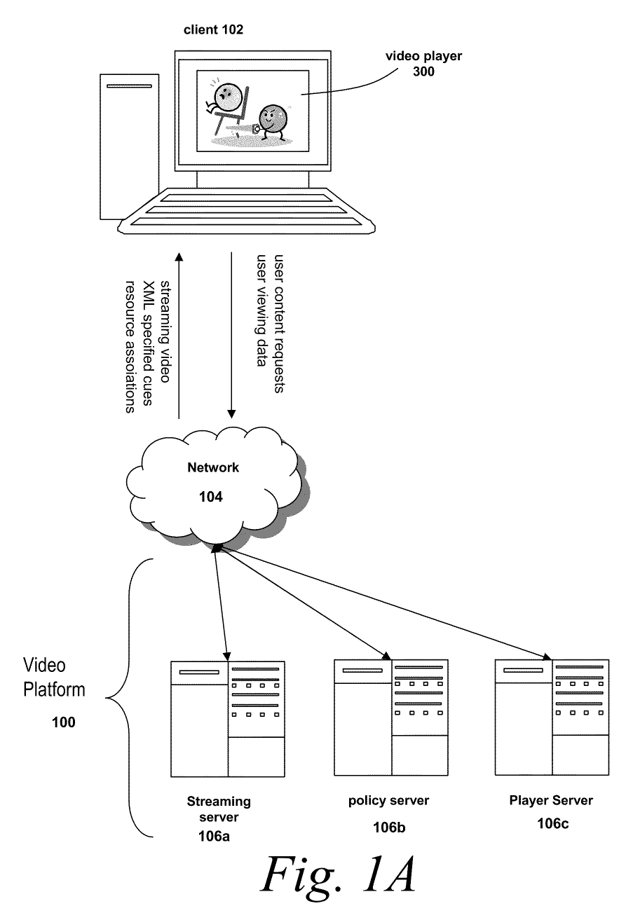

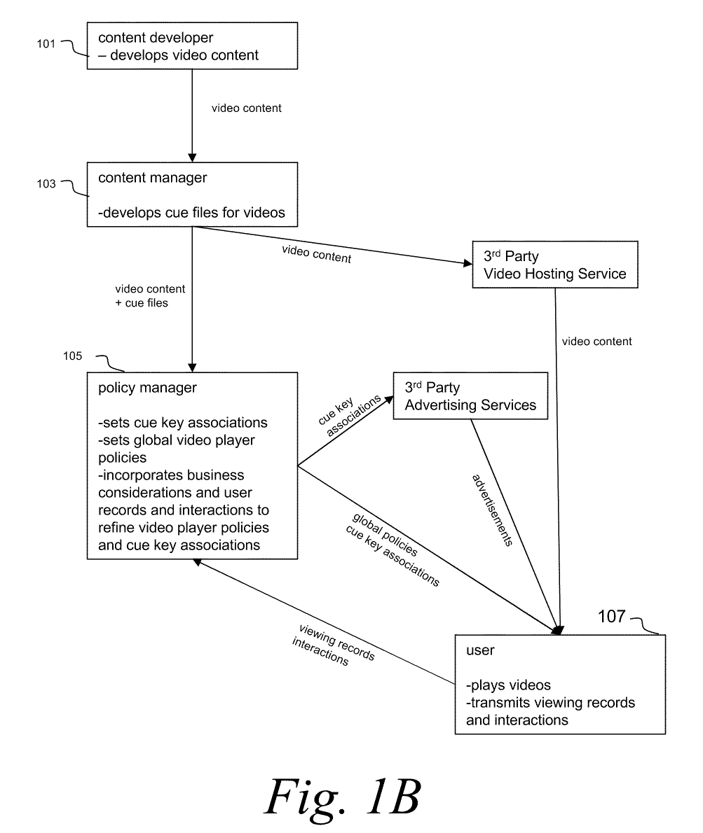

Referring now to FIG. 1A, a block diagram of one embodiment of a network which may be useful for distributing video is shown. In brief overview, the network comprises a client 102 which executes a video player 300. The client is connected via a network 104 to a number of servers: a streaming server 106a, a policy server 106b, and a player server 106c. Together these servers may be referred to a video platform 100. In some embodiments, some or all of the video platform 100 elements may occupy the same physical machine, and may share any resources, including processors, memory, and communication links. In other embodiments, a video platform 100 or any element of a video platform 100 may be distributed across multiple scalable, fault-tolerant, redundant machines. In some embodiments, these machines may be geographically distributed across a number of sites.

Still referring to FIG. 1A, now in greater detail, a client 102 executes a video player 300 which displays video content received from a video platform 100. A client may comprise any computing device capable of sending or receiving information. Examples of clients 102 may include personal computers, laptop computers, desktop computers, personal digital assistants, and mobile phones. A client 102 may include a display device, such as a monitor or screen, for displaying a web site to a user, and an input device, such as a keyboard or mouse, for accepting input of data corresponding to the video player. Although a single client is depicted, a video platform 100 may service any number of clients 102 sequentially and/or simultaneously.

As shown, the client 102 is connected to a video platform 100 via a network 104. The network 104 may comprise the Internet, local networks, web servers, file servers, routers, load balancers, databases, computers, servers, network appliances, or any other computing devices capable of sending and receiving information. The network 104 may comprise computing devices connected via cables, IR ports, wireless signals, or any other means of connecting multiple computing devices. The network and any devices connected to the networks may communicate via any communication protocol used to communicate among or within computing devices, including without limitation RMTP, Real Time Streaming Protocol (RTSP), Microsoft Media Server (MMS) protocol, Move Media Services leverage Quantum Streaming, RTCP, RTP, PNA (Progressive Networks Audio), SSL, HTML, XML, SOAP, AMF, REST, JSON, SFTP, RDP, ICA, FTP, HTTP, TCP, IP, UDP, IPX, SPX, NetBIOS, NetBEUI, SMB, SMTP, POP, IMAP, Ethernet, ARCNET, Fiber Distributed Data Interface (FDDI), RS232, IEEE 802. 11, IEEE 802.11a, IEE 802.11b, IEEE 802.11g and direct asynchronous connections, or any combination thereof. The network 104 may comprise mobile telephone networks utilizing any protocol or protocols used to communicate among mobile devices, including AMPS, TDMA, CDMA, GSM, GPRS or UMTS. The network may comprise a plurality of physically distinct networks, and the network may comprise a plurality of sub-networks connected in any manner.

A video platform 100 may comprise any server or servers capable of sending and receiving data. A video platform 100 may perform any function related to the delivery and processing of video, including without limitation serving and/or streaming videos, receiving and processing user requests, receiving and processing user information received from a video player 300, and distributing policies and key associations corresponding to a video. In some embodiments, some functions of a video platform may be split among multiple physical or logical devices. For example, a streaming server 106a may manage and deliver streaming video content to players, while a policy server 106b manages and transmits policies relating to requested videos, while a player server 106c may manage and deliver the video player 300 in response to user requests to download the functionality.

Referring now to FIG. 1B, a block diagram showing a system for enabling context-specific actions with respect to streaming video viewed in a web browser is shown. In brief overview the system comprises a content developer 101 which develops video content for viewing. The video content is sent to a content manager 103 which generates a cue file for the video content. A cue file may specify a correspondence between a number of keys and a number of portions of the video content. For example, the cue file may contain a representation that seconds 10-15 of the video content relate to the key “sushi.” The video content and cue file are then sent to a user 107 where it is played on a client 102 which plays the video and contains processing logic for processing the cue file in accordance with a set of policies received from a policy manager 105. The policy manager 105 may then adjust the policies or the cue files in response to information transmitted from the user about the user's viewing. Although the above paragraph and later paragraphs may refer to “cue files,” it should be understood that cue data may be stored and transmitted in any format. For example, cue data associated with videos may be stored in a database, and the cue data relating to a particular video may then be streamed to a user along with the video.

Still referring to FIG. 1B, now in greater detail, a content developer 101 may develop any video content in any manner. Video content may comprise any video developed for any purpose, including without limitation television shows, movies, commercials, infomercials, documentaries, interviews, home movies, video compilations, video montages. In some embodiments, the video content may be developed specifically for an internet audience. In other embodiments, the video content may be developed for any other medium, including broadcast or cable television. The video content may be stored in any format including without limitation AVI, Quicktime, WMV ASF, RM, FLV, and SWF. The video content may be encoded using any codec including without limitation MPEG, MPEG-1, MPEG-2, MPEG-4, MJPEG, DV, WMV, RM, DivX, Sorenson 3, Quicktime 6, RP9, WMV9, Ogg Theora, Dirac, VP6, VP7, H261, H262, H263, H264.

The content developer may pass the video content to a content manager 103. The content manager 103 may develop a cue file for the video content. A cue file may comprise any digital representation of a correspondence between a spatial or temporal portion of the video and a key. An example cue file, where an XML format is used to identify such correspondences is shown below. In the example below, a number of “timelineevents”, each with a title and type are specified. Examples of types include commentary, video advertisements, polls, graphics, and jumps to different times within the clip (specified below in the “utype” parameter). Each timeline event may have an associated stop or start time, and any associated data, such as text or graphics to display. Each timeline event may also have a parameter specifying whether the event is localized to a particular timepoint or occurs over a timespan (specified below in the “type” field).

```
<?xml version=″1.0″ encoding=″UTF-8″ standalone=″yes″?>
<ptv:cuefile xmlns:ptv=″http://www.permissiontv.com/xml/″ title=″Example Cue File″
ptvml=″panels/home.xml″ programId=12345>
    <ptv:timelineevents>
    <ptv:timelineevent id=111 title=”pre-roll” type=”point” utype=”video_ad”>
        <ptv:param name=″start″>00:00:00</ptv:param>
        <ptv:param name=″ad_server”>Ad_Co1</ptv:param>
        <ptv:param name=″keyword”>roofing</ptv:param>
        <ptv:param name=″campaign”>Home Building</ptv:param>
    </ptv:timelineevent>
    <ptv:timelineevent id=222 title=”3-Story” type=”span” utype=”commentary”>
        <ptv:param name=″start″>00:00:30</ptv:param>
        <ptv:param name=″end″>00:00:55</ptv:param>
        <ptv:param name=″track″>2</ptv:param>
        <ptv:param name=“text”>This was Earl’s first 3-story
project.</ptv:param>
    </ptv:timelineevent>
    <ptv:timelineevent id=333 title=”Useful” type=”point” utype=”poll”>
        <ptv:param name=″start″>00:02:15</ptv:param>
        <ptv:param name=″poll_id″>879</ptv:param>
        <ptv:param name=″keyword”>house</ptv:param>
    </ptv:timelineevent>
    <ptv:timelineevent id=444 title=”Locations” type=”span” utype=”graphic”>
        <ptv:param name=″start″>00:01:10</ptv:param>
        <ptv:param name=″end″>00:01:45</ptv:param>
        <ptv:param name=″graphic_id″>567</ptv:param>
        <ptv:param
name=″URL”>http://www.house_example.com/supplier_locations/?#loc#</ptv:param>
    </ptv:timelineevent>
    <ptv:timelineevent id=444 title=”25 Percent Off” type=”span”
utype=”graphic”>
        <ptv:param name=″start″>00:03:10</ptv:param>
        <ptv:param name=″end″>00:03:25</ptv:param>
        <ptv:param name=″graphic_id″>789</ptv:param>
        <ptv:param
name=“URL”>http://www.house_example.com/25off/?#offer#</ptv:param>
    </ptv:timelineevent>
    <ptv:timelineevent id=555 title=”Planning” type=”point” utype=”jump”>
        <ptv:param name=″start″>00:02:30</ptv:param>
        <ptv:param name=″keyword″>planning</ptv:param>
        <ptv:param name=″destination_prog”>23456</ptv:param>
        <ptv:param name=″destination_pos”>00:03:37</ptv:param>
    </ptv:timelineevent>
    <ptv:timelineevent id=666 title=”Table Saw” type=”span”
utype=”commentary”>
        <ptv:param name=″start″>00:05:15</ptv:param>
        <ptv:param name=″end″>00:05:35</ptv:param>
        <ptv:param name=″text”>Click to learn more about table
saws.</ptv:param>
        <ptv:param name=″destination_prog”>23456</ptv:param>
        <ptv:param name=″destination_pos”>00:00:00</ptv:param>
        <ptv:param name=″return_graphic”>2453</ptv:param>
    </ptv:timelineevent>
    <ptv:timelineevent id=777 title=”Table Saw” type=”hotspot”
utype=”graphic”>
        <ptv:param name=″start″>00:05:15</ptv:param>
        <ptv:param name=″end″>00:05:35</ptv:param>
        <ptv:param name=″destination_prog”>23456</ptv:param>
        <ptv:param name=″destination_pos”>00:00:00</ptv:param>
        <ptv:param name=″return_graphic”>2453</ptv:param>
        <ptv:graphicpath>
            <ptv:graphicposition time=start x=55
y=360></ptv:graphicposition>
            <ptv:graphicposition time=00:00:10 x=60
y=360></ptv:graphicposition>
            <ptv:graphicposition time=end x=65
y=360></ptv:graphicposition>
        </ptv:graphicpath>
    </ptv:timelineevent>
    </ptv:timelineevents>
</ptv:cuefile>
```

Although the cue file above is XML, any other language and/or markup language may be used including without limitation HTML and SVG.

A policy manager may create one or more policies relating to keys within the cue file. These policies may be created before or after the creation of the cue file. In some embodiments, a set of policies may be created which apply globally to any videos played by the video player. For example, a policy manager may wish to have a global policy that a ten-second commercial should be shown before every video. In other embodiments, a set of policies may be created which apply to any videos from a given domain. For example, a policy manager may create a policy that all videos from a site xyz.com should display commercials for xyz product whenever a commercial event is encountered. In still other embodiments, a set of policies may be created which apply to a given set of videos. For example, a policy manager may create a policy that all episodes of show A should link to brand Y's products whenever a given event occurs. In still other embodiments, a policy may be specific to a single video. In other embodiments, policies may specify actions based on information including without limitation, previous videos viewed, total viewing time, geo-location of viewer, responses to polls, site video is being viewed on, other pages visited, and graphic overlays selected. An example of a policy file is shown below. In the example below, an XML file specifies a number of policies to be applied to videos shown through a player, including without limitation a minimum clock time interval, the maximum number of ads that may be shown during a single session, an overlay or skin for the player.

```
<?xml version=″1.0″ encoding=″UTF-8″ standalone=″yes″?>
<ptv:adpolicy xmlns:ptv=″http://www.permissiontv.com/xml/″
title=″Example Ad Policy″ ptvml=″panels/home.xml″ id=12345>
    <ptv:param name=″min_clocktime_interval″>00:03:00</ptv:param>
    <ptv:param name=″max_session_ads″>5</ptv:param>
    <ptv: ad_call id=1111 type=”video”>
        <ptv:param name=″server″>www.ad_server1.com</ptv:param>
        <ptv:param name=″account_id″>”cl-3143-55b”</ptv:param>
        <ptv:param name=″context″>”house”</ptv:param>
        <ptv:param name=″temporal″>”summer”</ptv:param>
    </ptv:ad_call>
    <ptv:ad_call id=2222 type=”overlay”>
        <ptv:param name=″server″>www.ad_server2.com</ptv:param>
        <ptv:param name=″account_id″>”ab-e453”</ptv:param>
        <ptv:param name=″size″>71</ptv:param>
    </ptv:ad_call>
    <ptv:ad_call id=3333 type=”graphic-video”>
        <ptv:param name=″server″>www.ad_server3.com</ptv:param>
        <ptv:param name=″account_id″>”zz-568934542”</ptv:param>
        <ptv:param name=″graphic_id″>4521</ptv:param>
        <ptv:param name=″program_id″>3414</ptv:param>
    </ptv:ad_call>
</ptv:adpolicy>
```

Although the policy file above is XML, any other language and/or markup language may be used including without limitation HTML.

The cue file and video content may be passed to a user who plays the video content in a player equipped to process the video content in accordance with the cue A user may then receive the video content, cue file, and policy file and play the video via a video player that processes the video content according to the cue file and one or more policy files. The video player may transmit user data back to the policy manager relating to the viewed video content. Such user data may comprise any information relating to video content, including without limitation the length, identity, and number of videos watched, a user action such as clicking on a link or responding to a poll within a video, or a user activating or closing the video player at a given time. A policy manager may then use that data to calibrate future policies and/or future cue files. The policy manager may also report any of the data received to a content owner or distributor.

In some embodiments, the content developer, video editor, and policy manager may all be parts of a single corporate entity. In other embodiments, the content developer, video editor, and policy manager may comprise any number of different corporate or individual identities. For example, a television network may develop a television show, and then wish to make the episodes of that show available online. The network may then contact a separate company which provides an internet video player. The separate company may create the cue files and/or policy files, or alternatively, may provide the network with one or more tools for the network to create the cue files and/or policy files. The videos may then be delivered to users via a web site operated by the television network.

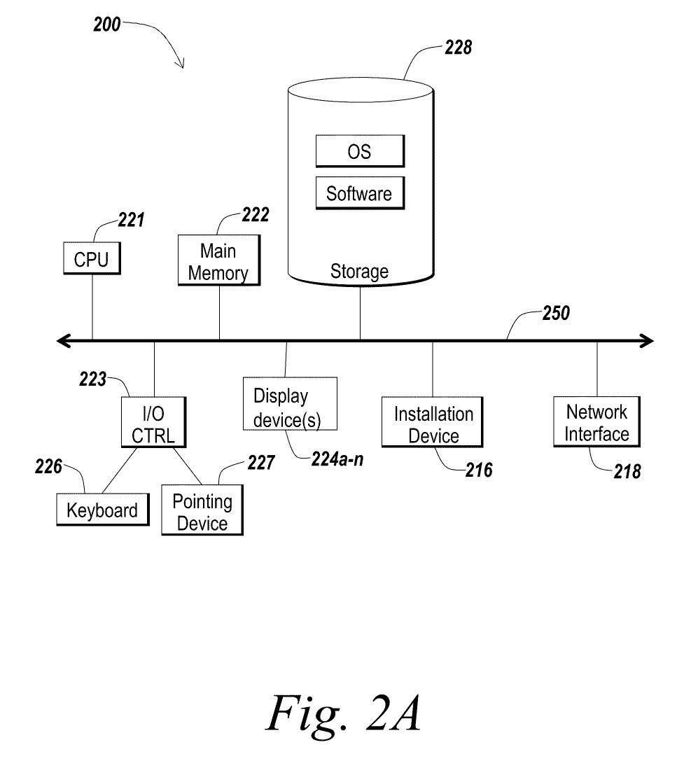

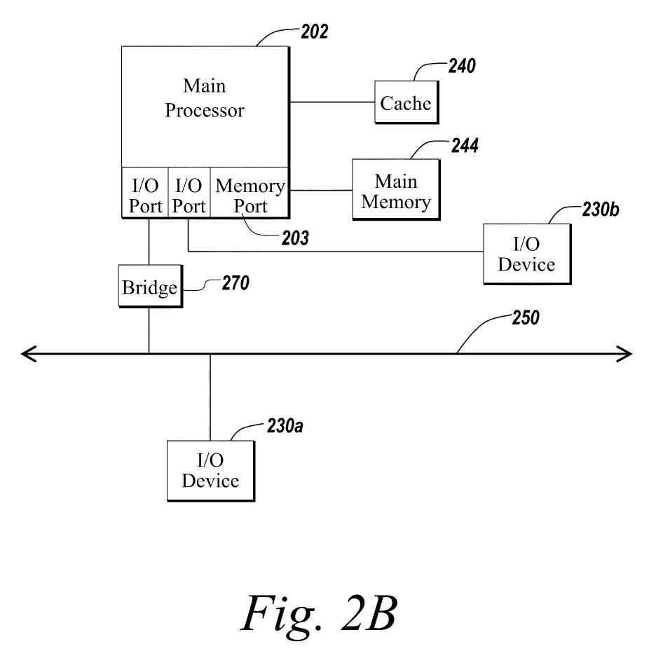

FIGS. 2A and 2B depict block diagrams of a typical computer 200 useful as client computing devices and server computing devices. As shown in FIGS. 2A and 2B, each computer 200 includes a central processing unit 202, and a main memory unit 204. Each computer 200 may also include other optional elements, such as one or more input/output devices 230a-230b (generally referred to using reference numeral 230), and a cache memory 240 in communication with the central processing unit 202.

The central processing unit 202 is any logic circuitry that responds to and processes instructions fetched from the main memory unit 204. In many embodiments, the central processing unit is provided by a microprocessor unit, such as those manufactured by Intel Corporation of Mountain View, Calif.; those manufactured by Motorola Corporation of Schaumburg, Ill.; the Crusoe and Efficeon lines of processors manufactured by Transmeta Corporation of Santa Clara, Calif.; the lines of processors manufactured by International Business Machines of White Plains, N.Y.; or the lines of processors manufactured by Advanced Micro Devices of Sunnyvale, Calif.

Main memory unit 204 may be one or more memory chips capable of storing data and allowing any storage location to be directly accessed by the microprocessor 202, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). In the embodiment shown in FIG. 2A, the processor 202 communicates with main memory 204 via a system bus 250 (described in more detail below). FIG. 2B depicts an embodiment of a computer system 200 in which the processor communicates directly with main memory 204 via a memory port. For example, in FIG. 2B the main memory 204 may be DRDRAM.

FIGS. 2A and 2B depict embodiments in which the main processor 202 communicates directly with cache memory 240 via a secondary bus, sometimes referred to as a “backside” bus. In other embodiments, the main processor 202 communicates with cache memory 240 using the system bus 250. Cache memory 240 typically has a faster response time than main memory 204 and is typically provided by SRAM, BSRAM, or EDRAM.

In the embodiment shown in FIG. 2A, the processor 202 communicates with various I/O devices 230 via a local system bus 250. Various busses may be used to connect the central processing unit 202 to the I/O devices 230, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is an video display, the processor 202 may use an Advanced Graphics Port (AGP) to communicate with the display. FIG. 2B depicts an embodiment of a computer system 200 in which the main processor 202 communicates directly with I/O device 230b via HyperTransport, Rapid I/O, or InfiniBand. FIG. 2B also depicts an embodiment in which local busses and direct communication are mixed: the processor 202 communicates with I/O device 230a using a local interconnect bus while communicating with I/O device 230b directly.

A wide variety of I/O devices 230 may be present in the computer system 200. Input devices include keyboards, mice, trackpads, trackballs, cameras, video cameras, microphones, and drawing tablets. Output devices include video displays, speakers, inkjet printers, laser printers, and dye-sublimation printers. An I/O device may also provide mass storage for the computer system 800 such as a hard disk drive, a floppy disk drive for receiving floppy disks such as 3.5-inch, 5.25-inch disks or ZIP disks, a CD-ROM drive, a CD-R/RW drive, a DVD-ROM drive, tape drives of various formats, and USB storage devices such as the USB Flash Drive line of devices manufactured by Twintech Industry, Inc. of Los Alamitos, Calif.

In further embodiments, an I/O device 230 may be a bridge between the system bus 250 and an external communication bus, such as a USB bus, an Apple Desktop Bus, an RS-132 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

General-purpose computers of the sort depicted in FIG. 2A and FIG. 2B typically operate under the control of operating systems, which control scheduling of tasks and access to system resources. Typical operating systems include: MICROSOFT WINDOWS, manufactured by Microsoft Corp. of Redmond, Wash.; MacOS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, among others.

For embodiments comprising mobile devices, the device may be a JAVA-enabled cellular telephone, such as the i55sr, i58sr, i85s, or the i88s, all of which are manufactured by Motorola Corp. of Schaumburg, Ill.; the 6035 or the 7135, manufactured by Kyocera of Kyoto, Japan; the iPhone manufactured by Apple Computer of Cupertino, Calif., or the i300 or i330, manufactured by Samsung Electronics Co., Ltd., of Seoul, Korea. In other embodiments comprising mobile devices, a mobile device may be a personal digital assistant (PDA) operating under control of the PalmOS operating system, such as the Tungsten W, the VII, the VIIx, the i705, all of which are manufactured by palmOne, Inc. of Milpitas, Calif. In further embodiments, the client 113 may be a personal digital assistant (PDA) operating under control of the PocketPC operating system, such as the iPAQ 4155, iPAQ 5555, iPAQ 1945, iPAQ 2215, and iPAQ 4255, all of which manufactured by Hewlett-Packard Corporation of Palo Alto, Calif.; the ViewSonic V36, manufactured by ViewSonic of Walnut, Calif.; or the Toshiba PocketPC e405, manufactured by Toshiba America, Inc. of New York, N.Y. In still other embodiments, the mobile device is a combination PDA/telephone device such as the Treo 180, Treo 270, Treo 600, Treo 650, Treo 700, or the Treo 700w, all of which are manufactured by palmOne, Inc. of Milpitas, Calif. In still further embodiments, the mobile device is a cellular telephone that operates under control of the PocketPC operating system, such as the MPx200, manufactured by Motorola Corp. A typical mobile device may comprise many of the elements described above in FIG. 2A and 2B, including the processor 202 and the main memory 204.

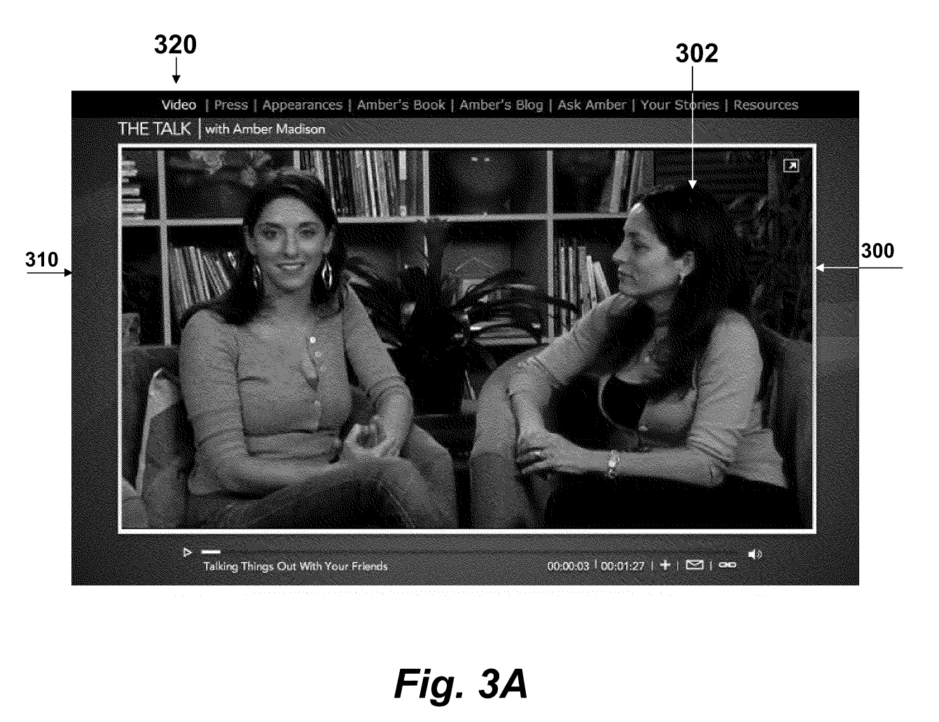

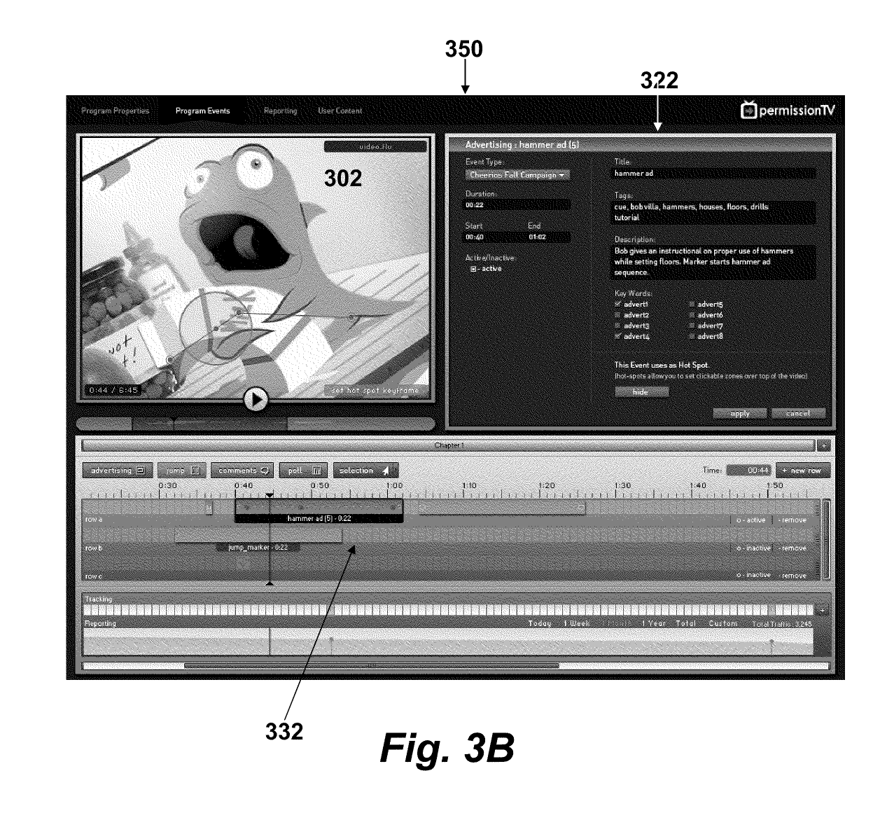

Referring now to FIG. 3A one embodiment of a video player executing in a web browser is shown. In brief overview, a web page 310 contains a video player 300 playing a video 302. The web page may also have any other elements 320 such as menus, navigation bars, test, and images capable of being displayed in a web page.

Still referring to FIG. 3A, now in greater detail, a video player may display in a web page shown by a web browser. The video player may be implemented using any programming elements, including without limitation scripts, plug-ins, or applets. The video player may be displayed in any manner. In some embodiments, a video player 300 may have a uniform look regardless of the videos it is playing or the site it is embedded in. In other embodiments, a video player 300 may have a customized display for one or more web sites. The customized display may include altering the size, layout, color, skin, wrapper, interface, or any other graphical element of the player.

Referring now to FIG. 3B an example screenshot of a video editor for which allows context-specific actions in relation to played videos. In brief overview a video editor 350 provides a graphical interface for editing a video 302, including an event interface 322 for specifying information about an event during the video and a timeline interface 332 which allows a user to view a number of events corresponding to the video along a timeline.

Still referring to FIG. 3B, now in greater detail, a video editor 350 may comprise any interface for specifying information corresponding to video content. In the example shown, an event interface 322 allows a user to specify an event with respect to a current video 302. The timeline interface 332 which allows a user to view a timeline of events associated with a video. In some embodiments, the user may be able to select areas along the timeline of the video 302 within the timeline to create new events. Additionally, a user may provide information necessary to automatically create multiple events along video 302. For example, an event to track viewing may be requested at every 15 seconds along video 302.

A video editor 350 may also comprise an event interface 322 which may accept input of any information pertaining to a specific event, including start and end time, physical location, keywords, event type, description, and an associated advertising campaign. In some embodiments, some of this event information may be automatically filled in. For example, a user may be able to drag an area within the video 302 to specify a location and time corresponding to an event.

After data corresponding to a video 302 has been entered, a video editor 350 may create any number of files for storing the event data. In one embodiment, the video editor 350 may generate one or more cue files specifying event information entered via the video editor 350.

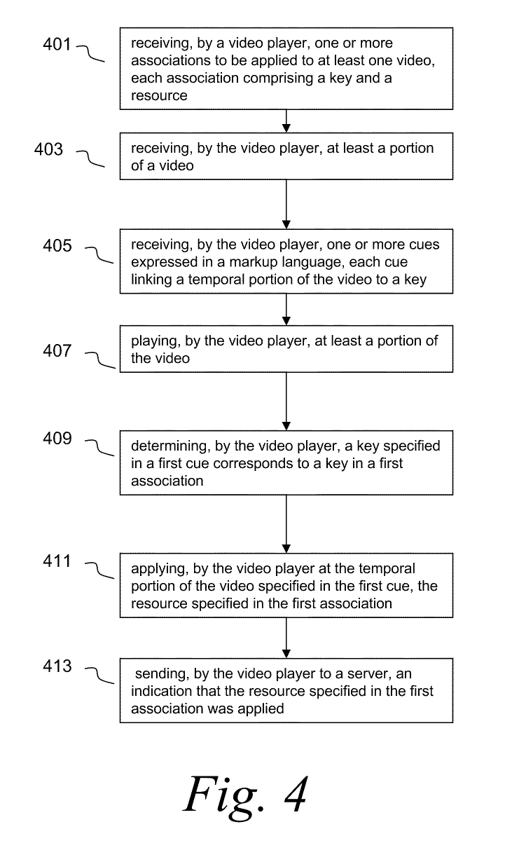

Referring now to FIG. 4 a flow diagram of one embodiment of a method for enabling context-specific actions with respect to streaming video viewed in a web browser is shown. In brief overview, a video player receives one or more associations to be applied to at least one video, each association comprising a key and a resource (step 401). The video player receives at least a portion of a video (step 403); and receives one or more cues expressed in a markup language, each cue linking a temporal portion of the video to a key (step 405). The video player may then play at least a portion of the video (step 407) and determine a key specified in a first cue corresponds to a key in a first association (step 409). The video player may then apply, at the temporal portion of the video specified in the first cue, the resource specified in the first association (step 411). The video player may also send, to a server, an indication that the resource specified in the first association was applied (step 413). The method may be performed by any computing device or any plurality of computing devices.

Still referring to FIG. 4, now in greater detail, a video player may receive in any manner one or more associations to be applied to at least one video, each association comprising a key and a resource (step 401). In some embodiments, a video player may receive the one or more associations prior to receiving any videos. In other embodiments, a video player may receive the one or more associations during or after receiving one or more videos. In some embodiments, the one or more associations may be transmitted along with a download of the video player. For example, a client may visit a web page which downloads the video player to the client along with a set of one or more associations. In others embodiments, the one or more associations may be received in addition to one or more associations previously received.

The one or more associations may be received from any source. In one embodiment, the associations may be received from a policy server 106b. In another embodiment, the associations may be received from the same server from which video content is received. In still another embodiment, the associations may be received from a web server as part of a web page comprising the video and/or video player.

In some embodiments, the one or more associations may take the form of one or more policies. In some embodiments, one or more policies and/or associations may be arranged in a hierarchy.

A key may comprise any type or form of identifier, including without limitation a string, number, alphanumeric sequence, symbol, bit sequence, or byte sequence. In some embodiments, a key may be an identifier created within the video player system. In other embodiments, a key may have external meaning as well. For example, a key may comprise a UPC or SKU number for a product. In some embodiments, a key may be globally unique. For example, a given television show may be assigned a globally unique identifier to distinguish it from all other television shows. Or for example, a single key may be selected to refer to a given brand, product, or item across all videos. In other embodiments, a key may be locally unique to a set of videos. For example, within one video, (a cooking show, for example) the key “chips” may be used to designate potato chips, while “chips” within a technology show may be used to designate microchips.

A resource associated with a key may comprise any element including without limitation a URL, a video, an image, a text element, a sound, a policy, an interactive element. Interactive elements may include without limitation games, polls, surveys, purchase options, rating, comment, advertising opt-ins, other flash files and/or decision screens. In some embodiments, a resource may be received along with the association. For example, if an association associates a policy with an image to be displayed, in some embodiments the image file may be received along with the association. In other embodiments, a link to the image file may be provided, and the video player may download the resource on an as-needed basis.

In some embodiments, the association between a key and a resource may be an unconditional association—e.g. “anytime key X is encountered, apply resource Y.” In other embodiments, an association may be conditional. For example, an association may take the form of “when key X is encountered, play resource Y IF no other resource has been applied within the past 2 minutes.” In some embodiments, the conditions contained in an association may be hierarchical in nature or based on an external context.

In some embodiments, an association may associate a plurality of keys with a given resource. In other embodiments, an association may association a plurality of resources with a given key.

A video player may receive at least a portion of a video in any manner (step 403). In some embodiments, the video player may receive the portion via streaming. In other embodiments, the portion may be downloaded and saved. In other embodiments, the portion may be progressively downloaded. In some embodiments, the video may be received from a server. In other embodiments, the video may be received from a peer.

The portion of the video may comprise any portion of any video content. In some embodiments, the portion may comprise the entirety of the video content. In some embodiments, the portion may comprise a time segment of a video. In some embodiments, the video player may receive a plurality of portions of a video. These portions may be received sequentially and/or simultaneously. In some embodiments, a video player may receive a portion of a plurality of videos.

The portion of the video may be received in response to a request from the video player and/or a request from a user of the video player. For example, a user may click on a link or otherwise indicate a desire to watch a given video. This request may then be sent to a server, and the video may then be sent to the player. In other embodiments, the portion of the video may be transmitted without receiving a request from the video player and/or a user of the video player. For example, a video player may process a policy with respect to a currently viewed video and determine that a second video should be played as a commercial during the currently viewed video. The video player may transmit a request for the second video and then receive one or more portions of that video. Or for example, a video player may transmit a non-specific request for a commercial, upon which a server determines a video to send to the video player.

The video player may receive one or more cues expressed in a markup language, each cue linking a temporal portion of the video to a key in any manner (step 405). In some embodiments, the video player may receive a cue file comprising one or more cues. The video player may receive the one or more cues at any time, including before, during, or after receiving the portion of the video and the one or more associations. In some embodiments, a video player may delay playing a portion of a video until the video player has received a corresponding cue file.

The video player may then play at least a portion of the video in any manner (step 407). In some embodiments, the played portion may comprise the received portion of the video. In other embodiments, the played portion may comprise a subset of the received portion of the video. In some embodiments, the video player may play the video in response to a user action, such as a user clicking on a link or clicking a “play” button. In other embodiments, the video player may play the video without user input.

The video player may determine a key specified in a first cue corresponds to a key in a first association in any manner (step 409). In some embodiments, the video player may use a hash table or any other search or sorting method to determine whether a key specified in a cue corresponds to a key contained in an association or policy. In some embodiments, a video player may determine that a key in a cue corresponds to a key in a plurality of associations. In these circumstances, the video player may apply all of the associations, or use a policy hierarchy or other decision logic to determine which association to apply.

The video player may then apply, at the temporal portion of the video specified in the first cue, the resource specified in the first association in any manner (step 411). A temporal portion may comprise any timing indication related to the video. In some embodiments, the indicated temporal portion may be a single point in time. In other embodiments, the indicated temporal portion may comprise a time span. In some embodiments, the temporal portion indicated may comprise the entirety of the video.

In some embodiments, the cue may specify a screen location in addition to the temporal location. For example, the cue may specify certain pixel x and y coordinates within the video. In other embodiments, the cue may specify a changing screen location over an indicated time span. For example, the cue may specify a first set of coordinates for a first second of the time span, and a second and third set of coordinates for the second and third seconds of the time span. In these embodiments, the video player may interpolate coordinates between one or more sets of coordinates. For example, a cue may specify a first set of coordinates at time 0, and a second set of coordinates at time 8. At time 4, the video player may apply the specified resource to a set of coordinates interpolated between the first and second set. In these embodiments, any interpolation method may be used. For example, a straight-line smoothing algorithm may be used consisting of the following. A graphic is given a path consisting of moving its top left position defined by X_{G} and Y_{G} moving from origin coordinate X_{O} and Y_{O} to destination coordinate X_{D} and Y_{D} in equal increments over interval T. Inverval T is determined by a provided start time T_{O} and end time T_{D}. At any point in time, T₁, the position of the graphic (X_{G}, Y_{G}) is set equal to (X₁, Y₁) by the formula:

X₁=X_{O}+((X_{D}−X_{O})*((T₁−T_{O})/(T_{D}−T_{O})))

Y₁=Y_{O}+((Y_{D}−Y_{O})*((T₁−T_{O})/(T_{D}−T_{O})))

Applying the resource may comprise any use or display of the resource. In some embodiments, applying a resource may comprise executing the resource, such as if the resource is a policy or a script or an executable file. In other embodiments, applying a resource may comprise displaying or playing the resource, such as if the resource is a text string, image, sound file, or video. In still other embodiments, applying a resource may comprise transmitting a message, such as if the resource is an address where user feedback relating to the video can be sent. In some embodiments, a user may be given a choice as to whether a resource should be applied.

In some embodiments, the video player may pause, stop, or otherwise suspend playing the video while the resource is applied. For example, if the resource is another video, the video player may stop the current video to begin playing the other video. After the other video is finished, the video player may then return to playing the previous video. In other embodiments, the video player may continue to play the video while the resource is being applied.

In some embodiments, the video player may send, to a server, an indication that the resource specified in the first association was applied (step 413). The indication may comprise any information regarding the application of the resource, and may be transmitted in any manner and at any time. In some embodiments, the video player may send the indication substantially simultaneously or soon after the resource is applied. In other embodiments, the video player may store a record of the resource being applied and transmit the record to the server at a later time.

A video player may send any information regarding the application of a resource including without limitation the time, duration, and context wherein a resource was applied. A video player may also send any information relating to a user response to the applied resource. For example, a video player may send information indicating that at 15:34 June 14, video “A” was played as a commercial during video “B.” The video player may also send information regarding whether the user positively responded to the commercial video, such as by clicking on an advertisement within the video, or negatively responded to the video, such as by closing, muting, or minimizing the video. Additional reporting information may include: program played, actual video file played, date/time of player, IP address of computer, unique session id of browser, browser version, percent of video played in pre-determined increments, player, containing page of video play, referring page of video play, user identifier

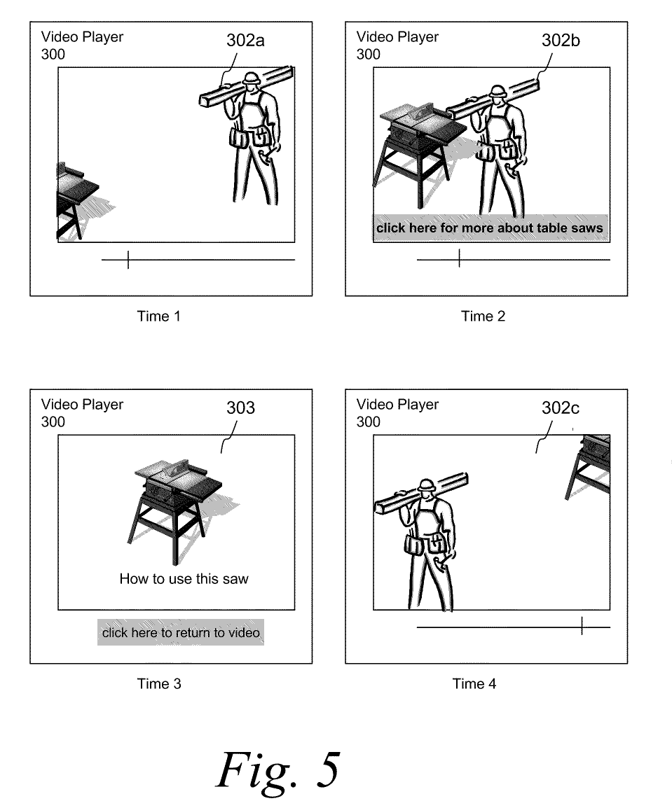

Referring now to FIG. 5 one example of a video player processing a cue covering a time span is shown. In brief overview, a video player 300 displays a video 302 of a carpenter using a table saw. The video may be accompanied by a cue file which indicates a portion of the video during which the table saw is onscreen. A policy file may indicate that when a table saw is onscreen (302b), the text “click to learn about table saws” should be displayed, in addition to causing a user click on the video to link to a video or other material relating to table saws (303). In some embodiment, the text may not be displayed and any other indication may be used to indicate that a user click on the video will trigger a link.

Still referring to FIG. 5, now in greater detail a video player 300 may play the video 302. The video may be received along with a cue file, such as the one below, which directs the text “Click to learn more about table saws.” to be shown during a specific time interval.

```
<?xml version=″1.0″ encoding=″UTF-8″ standalone=″yes″?>
<ptv:cuefile xmlns:ptv=″http://www.permissiontv.com/xml/″
title=″Example Cue File″ ptvml=″panels/home.xml″
programId=12345>
    <ptv:timelineevents>
    <ptv:timelineevent id=666 title=”Table Saw” type=”span”
utype=”commentary”>
        <ptv:param name=″start″>00:05:15</ptv:param>
        <ptv:param name=″end″>00:05:35</ptv:param>
        <ptv:param name=″text”>Click to learn more about table
saws.</ptv:param>
        <ptv:param name=″destination_prog”>23456</ptv:param>
        <ptv:param name=″destination_pos”>00:00:00</ptv:param>
        <ptv:param name=″return_graphic”>2453</ptv:param>
    </ptv:timelineevent>
    </ptv:timelineevents>
</ptv:cuefile>
```

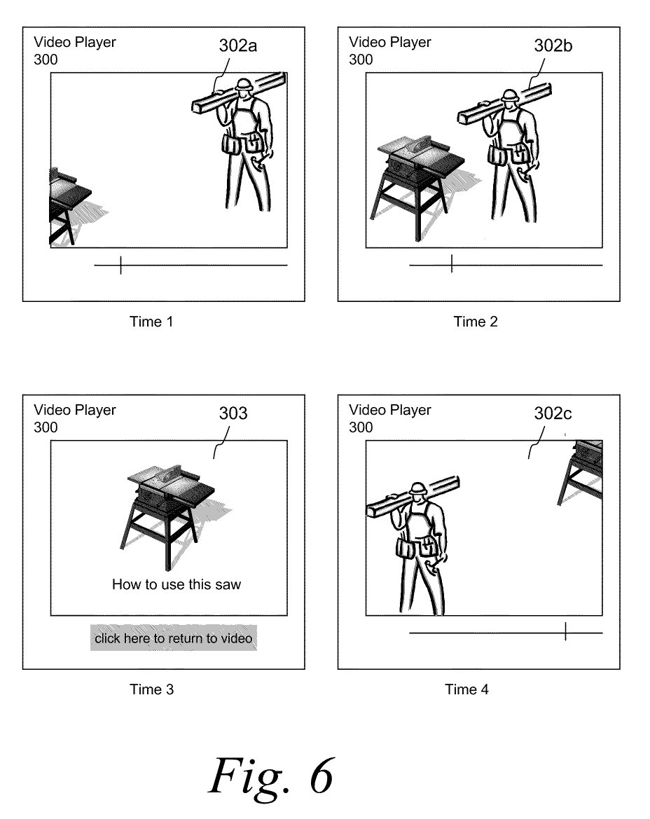

Referring now to FIG. 6, a second example of a video player processing a cue covering a time span is shown. In brief overview, a video player 300 displays a video 302 of a carpenter using a table saw. The video may be accompanied by a cue file which indicates a duration and location of the video during which the table saw is onscreen. A policy file may indicate that when a table saw is onscreen (302b), the video screen area displaying the table saw be highlighted and selectable, in addition to causing a user click on the table saw to link to a video or other material relating to table saws (303). In some embodiment, the highlight may not be displayed and any other indication may be used to indicate that a user click on the video area will trigger an action.

Still referring to FIG. 6, now in greater detail a video player 300 may play the video 302. The video may be received along with a cue file, such as the one below, which specifies the location and duration of the clickable portion of the video.

```
<?xml version=″1.0″ encoding=″UTF-8″ standalone=″yes″?>
<ptv:cuefile xmlns:ptv=″http://www.permissiontv.com/xml/″
title=″Example Cue File″ ptvml=″panels/home.xml″
programId=12345>
    <ptv:timelineevents>
    <ptv:timelineevent id=777 title=”Table Saw” type=”hotspot”
utype=”graphic”>
        <ptv:param name=″start″>00:05:15</ptv:param>
        <ptv:param name=″end″>00:05:35</ptv:param>
        <ptv:param name=″destination_prog”>23456</ptv:param>
        <ptv:param name=″destination_pos”>00:00:00</ptv:param>
        <ptv:param name=″return_graphic”>2453</ptv:param>
        <ptv:param name=″highlightcolor”>”pink”</ptv:param>
        <ptv:graphicpath>
            <ptv:graphicposition time=start x=55
y=360></ptv:graphicposition>
            <ptv:graphicposition time=00:00:10 x=60
y=360></ptv:graphicposition>
            <ptv:graphicposition time=end x=65
y=360></ptv:graphicposition>
        </ptv:graphicpath>
    </ptv:timelineevent>
    </ptv:timelineevents>
</ptv:cuefile>
```

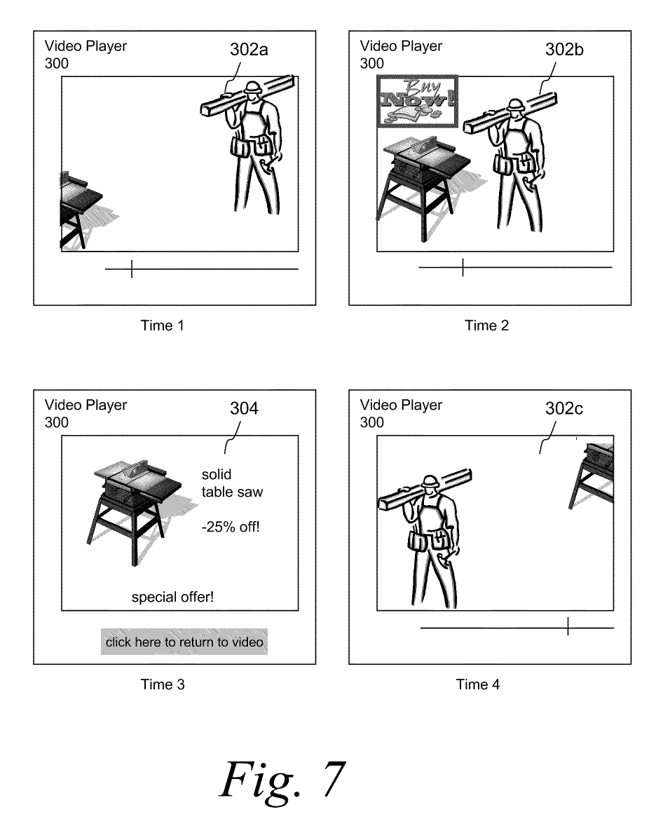

Referring now to FIG. 7, an example of a video player processing a cue covering a specific time point is shown. In brief overview, a video player 300 displays a video 302 of a carpenter using a table saw. The video may be accompanied by a cue file which indicates a specific point of the video during which the table saw is onscreen. A policy file may indicate that when a table saw is onscreen (302b), a graphic linking to a commercial video or image for a specific saw should be shown, in addition to causing a click on the graphic to link to a video or other material relating to table saws (304) Still referring to FIG. 7, now in greater detail a video player 300 may play the video 302. The video may be received along with a cue file, such as the one below which specifies an advertisement graphic to be displayed during a specific time of the video.

```
<?xml version=″1.0″ encoding=″UTF-8″ standalone=″yes″?>
<ptv:cuefile xmlns:ptv=″http://www.permissiontv.com/xml/″
title=″Example Cue File″ ptvml=″panels/home.xml″
programId=12345>
    <ptv:timelineevents>
    <ptv:timelineevent id=444 title=”25 Percent Off” type=”span”
utype=”graphic”>
        <ptv:param name=″start″>00:03:10</ptv:param>
        <ptv:param name=″end″>00:03:25</ptv:param>
        <ptv:param name=″graphic_id″>789</ptv:param>
        <ptv:param
name=“URL”>http://www.house_example.com/25off/?#offer#
</ptv:param>
    </ptv:timelineevent>
    </ptv:timelineevents>
</ptv:cuefile>
```

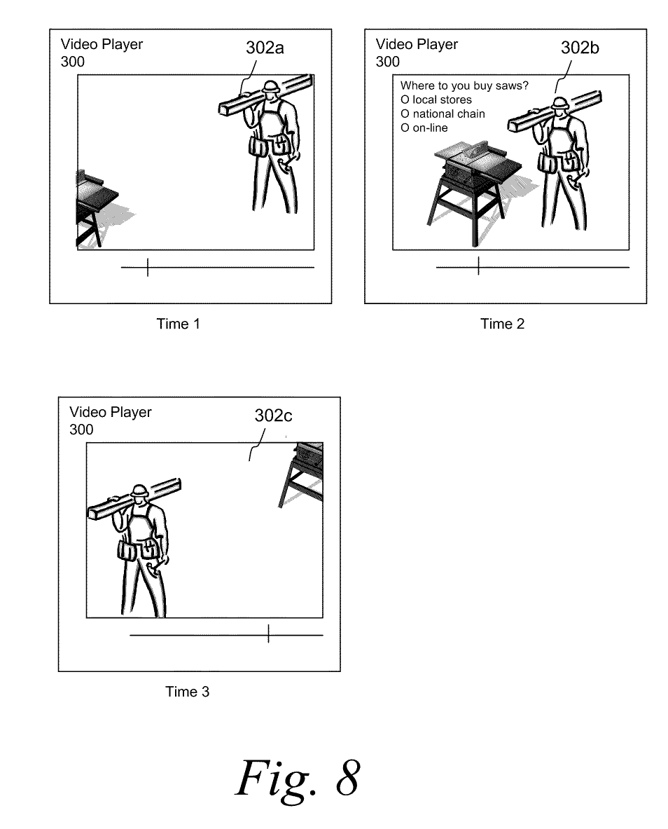

Referring now to FIG. 8, a second example of a video player processing a cue covering a specific time point is shown. In brief overview, a video player 300 displays a video 302 of a carpenter using a table saw. The video may be accompanied by a cue file which indicates a specific point of the video during which the table saw is onscreen. A policy file may indicate that when a table saw is onscreen (302b), a poll or other interactive element should be displayed to determine the interest of the viewer in a related topic.

Still referring to FIG. 8, now in greater detail a video player 300 may play the video 302. The video may be received along with a cue file, such as the one below which specifies a poll which occurs at a designated portion of the video.

```
<?xml version=″1.0″ encoding=″UTF-8″ standalone=″yes″?>
<ptv:cuefile xmlns:ptv=″http://www.permissiontv.com/xml/″
title=″Example Cue File″ ptvml=″panels/home.xml″
programId=12345>
    <ptv:timelineevents>
    <ptv:timelineevent id=333 title=”Supplies” type=”span”
    utype=”poll”>
        <ptv:param name=″start″>00:02:15</ptv:param>
        <ptv:param name=″end″>00:02:35</ptv:param>
        <ptv:param name=″poll_id″>880</ptv:param>
        <ptv:param name=″keyword”>house</ptv:param>
    </ptv:timelineevent>
    </ptv:timelineevents>
</ptv:cuefile>
```

The poll may also be specified in an XML file, such as the one below.

```
<?xml version=″1.0″ encoding=″UTF-8″ standalone=″yes″?>
<ptv:polls xmlns:ptv=″http://www.permissiontv.com/xml/″>
  <ptv:poll id=″879″>
    <ptv:param attributeId=″1″ name=″title″>Was this ad useful?</ptv:param>
    <ptv:param attributeId=″573″ name=″poll-question″>Was this ad
useful?</ptv:param>
    <ptv:param attributeId=″574″ name=″poll-response-1″>not at all</ptv:param>
    <ptv:param attributeId=″575″ name=″poll-response-2″>some</ptv:param>
    <ptv:param attributeId=″576″ name=″poll-response-3″>very much</ptv:param>
  </ptv:poll>
  <ptv:poll id=″880″>
    <ptv:param attributeId=″1″ name=″title″>Saws purchasing </ptv:param>
    <ptv:param attributeId=″573″ name=″poll-question″>Where do you buy saws?
</ptv:param>
    <ptv:param attributeId=″574″ name=″poll-response-1″>local store</ptv:param>
    <ptv:param attributeId=″575″ name=″poll-response-2″>national
chain</ptv:param>
    <ptv:param attributeId=″576″ name=″poll-response-3″>on-line
ordering</ptv:param>
  </ptv:poll>
</ptv:polls>
```

While the invention has been particularly shown and described with reference to specific preferred embodiments, it should be understood by those skilled in the art that various changes in form and detail may be made therein departing from the spirit and scope of the invention as defined by the appended claims.

We claim:

1. A method for enabling context-specific actions with respect to streaming video viewed in a web browser, the method comprising:
a. receiving, by a video player, one or more associations to be applied to at least one video, each association comprising a key and a resource;
b. receiving, by the video player, at least a portion of a video;
c. receiving, by the video player, one or more cues expressed in a markup language, each cue linking a temporal portion of the video to a key;
d. playing, by the video player, at least a portion of the video;
e. determining, by the video player, a key specified in a first cue corresponds to a key in a first association; and
f. applying, by the video player at the temporal portion of the video specified in the first cue, the resource specified in the first association.

2. The method of claim 1, wherein each resource comprises one or more elements selected from the group of: a URL, a video, an image, a text element, or an interactive element.

3. The method of claim 1, wherein step (a) comprises receiving, by the video player, one or more associations to be applied to a plurality of videos, each association comprising a key and a resource.

4. The method of claim 1, wherein the video player operates within a web browser.

5. The method of claim 1, wherein step (b) comprises receiving, by a video player, a portion of a streamed video.

6. The method of claim 1, wherein step (c) comprises receiving, by the video player, a cue expressed in a markup language, the cue linking a temporal portion and a spatial portion of the video to a key.

7. The method of claim 1, wherein step (c) comprises receiving, by the video player, a cue expressed in a markup language, the cue linking a plurality of temporal portions and a plurality of spatial portions of the video to a key.

8. The method of claim 1, wherein the temporal portion comprises a single time point.

9. The method of claim 1, wherein step (f) comprises playing a video resource at a time specified by the first cue.

10. The method of claim 1, wherein step (f) comprises displaying an image resource during a time specified by the first cue.

11. The method of claim 1, wherein step (f) comprises embedding a link resource into the video during a time specified by the first cue.

12. The method of claim 1, wherein step (f) comprises embedding a link resource into the video during a time and at a location specified by the first cue.

13. The method of claim 1, further comprising sending, by the video player to a server, an indication that the resource specified in the first association was applied.

14. The method of claim 1, further comprising sending, by the video player to a server, an indication of a user action with respect to the resource specified in the first association that was applied.

15. A client for enabling context-specific actions with respect to streaming video viewed in a web browser, the client comprising:
a transceiver which receives: at least a portion of a video, receives one or more associations to be applied to the at least one video, each association comprising a key and a resource, and receives one or more cues expressed in a markup language, each cue linking a temporal portion of the video to a key; and
a processor which executes a video player, the video player playing at least a portion of a video; determines a key specified in a first cue corresponds to a key in a first association; and applies, at the temporal portion of the video specified in the first cue, the resource specified in the first association.

16. The system of claim 15, wherein each resource comprises one or more elements selected from the group of: a URL, a video, an image, a text element, or an interactive element.

17. The system of claim 15, wherein the transceiver receives one or more associations to be applied to a plurality of videos, each association comprising a key and a resource.

18. The system of claim 15, wherein the processor executes the video player within a web browser.

19. The system of claim 15, wherein the transceiver receives a portion of a streamed video.

20. The system of claim 15, wherein the transceiver receives a cue expressed in a markup language, the cue linking a temporal portion and a spatial portion of the video to a key.

21. The system of claim 15, wherein the transceiver receives a cue expressed in a markup language, the cue linking a plurality of temporal portions and a plurality of spatial portions of the video to a key.

22. The system of claim 15, wherein the temporal portion comprises a single time point.

23. The system of claim 15, wherein the processor plays a video resource at a time specified by the first cue.

24. The system of claim 15, wherein the processor displays an image resource during a time specified by the first cue.

25. The system of claim 15, wherein the processor embeds a link resource into the video during a time specified by the first cue.

26. The system of claim 15, wherein the processor embeds a link resource into the video during a time and at a location specified by the first cue.

27. The system of claim 15, wherein the transceiver sends, to a server, an indication that the resource specified in the first association was applied.

28. The system of claim 15, wherein the transceiver sends, to a server, an indication of a user action with respect to the resource specified in the first association that was applied.
